(19) United States
(12) Patent Application Publication
(10) Pub. No.: US 2004/0081594 A1
(43) Pub. Date: Apr. 29, 2004

(54) Seamless catalytic converter comprising inner heat shield

(76) Inventors: Houliang Li, Novi, MI (US); Joseph Michael Lanzesira, Monroe, MI (US); Earl T. Nelson, Livonia, MI (US)

Correspondence Address: VISTEON 29074, BRINKS HOFER GILSON & LIONE, P.O. BOX 10395, CHICAGO, IL, 60611, US

(21) Appl. No.: 10/282,675

(22) Filed: Oct. 29, 2002

(51) Int. Cl. B01D 53/34

(52) U.S. Cl. 422/179; 422/177; 422/180

(57) ABSTRACT

A catalytic converter for an automotive exhaust system or the like comprises a catalyst substrate disposed within a seamless metal housing preferably formed by a spin-forming process. The housing includes a midsection surrounding a catalyst substrate and an end section that extends from the midsection and defines an opening, which may be either an inlet or an outlet for the converter. An inner heat shield is affixed to the housing end section at the opening and includes a frustoconical section that is disposed about the substrate such that the substrate end is received in the frustoconical section. The frustoconical section is spaced apart from the first housing end section to insulate the housing end section from the heat of the exhaust gases and thereby reduces the temperature of the metal housing.

### TECHNICAL FIELD OF THE INVENTION

This invention relates to a catalytic converter comprising a seamless metal housing having an end section that forms an inlet or outlet for exhaust gas. More particularly, this invention relates to such catalytic converter further comprising a frustoconical heat shield disposed within the end section to reduce the housing temperature during operation.

### BACKGROUND OF THE INVENTION

Automotive vehicles are equipped with a catalytic converter for treating exhaust gases to reduce noxious compounds prior to emission into the atmosphere. A typical catalytic converter comprises a catalyst substrate that is formed of a ceramic material and defines a plurality of gas passages coated with a catalytic material. The catalyst substrate is enclosed within a metal housing that includes end sections that are connected to exhaust pipes and provide an inlet and an outlet for admitting and emitting gas. During operation, exhaust gases enter the converter through the inlet, flow through the gas passages of the catalyst substrate and are treated by the catalyst, and exit through the outlet.

It is known to manufacture a seamless metal housing for a catalytic converter housing from a metal tube by spin-forming the end sections to form the inlet and outlet. During spin-forming, the metal tube is rotated about a longitudinal axis relative to a metal forming tool. The metal forming tool is urged radially against the metal and axially advanced to progressively reduce the metal circumference and form a desired shape for the housing end section.

During operation, the housing is heated by the high temperatures of the exhaust gas and by heat generated by the gas treatment. It is known to provide an external heat shield about the converter to protect nearby objects from the heat. However, this increases the space needed for the converter on the vehicle and is not desirable. Within the converter, the catalyst substrate is wrapped in thermal insulation to reduce heat transfer to the surrounding midsection of the housing. Nevertheless, heat is transferred to the housing by the exhaust gases within the inlet and outlet sections of the housing.

Therefore, a need exists for a catalytic converter comprising a seamless metal housing that includes an end section, which may be an inlet or outlet section, and also includes a heat shield within the end section to reduce heat transfer from the exhaust gases and thereby reduce the temperature of the housing.

### BRIEF SUMMARY OF THE INVENTION

In accordance with a preferred embodiment of this invention, a catalytic converter is provided for an automotive exhaust system or the like. The catalytic converter comprises a catalyst substrate having a substrate axis and including a plurality of axial gas passages that extend between a first end and a second end. The catalytic converter also includes a seamless metal housing having midsection about the catalyst substrate. The housing includes a first housing end section that extends from the midsection adjacent the first substrate end and defines an opening spaced apart from the substrate, which opening may be either an inlet or an outlet of the converter. In accordance with this invention, the catalytic converter also includes an inner heat shield affixed to the housing end section at the opening. The inner heat shield includes a frustoconical section that is disposed within the housing end section. the frustoconical section has an enlarged open end that extends about the substrate, such that the first substrate end is received in the frustoconical section. In addition, the frustoconical section is spaced apart from the first housing end section to form an insulative space therebetween. During operation, the housing is insulated from the heat of exhaust gases passing through the housing end section by the inner heat shield and the insulative space, thereby reducing the temperature of the housing.

In one aspect of this invention, the opening in the metal housing, which may be either an inlet or outlet for the converter, is disposed about an axis corresponding to the axis of the catalyst substrate. Alternately, this invention is suitable for providing an opening that is not coincident with the substrate axis. In another aspect, the opening may be disposed about an axis that intersects the substrate axis at an oblique angle. Alternately, the opening may be disposed about an axis that is parallel to and offset from the substrate axis.

### BRIEF DESCRIPTION OF THE DRAWINGS

The present invention will be further illustrated with reference to the accompanying drawings wherein:

FIG. 1 is a cross-sectional view of a catalytic converter formed in accordance with a preferred embodiment of this invention;

FIG. 2 is a cross-sectional view showing an arrangement of components for forming the catalytic converter in FIG. 1;

FIG. 3 is a cross-sectional view of a catalytic converter in accordance with an alternate embodiment of this invention; and

FIG. 4 is a cross-sectional view of a catalytic converter in accordance with still another embodiment of this invention.

### DETAILED DESCRIPTION OF THE INVENTION

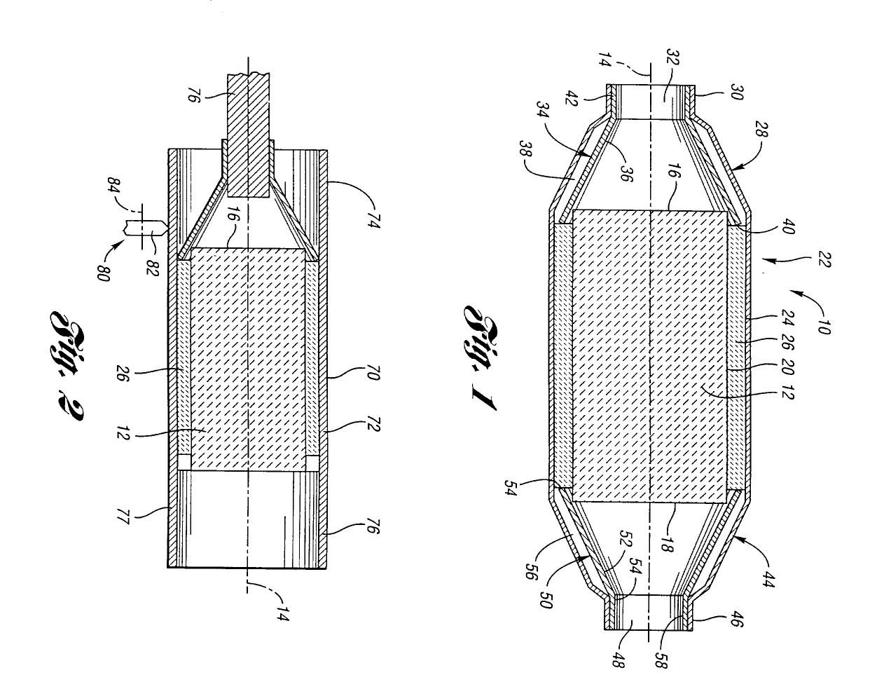

In accordance with a preferred embodiment of this invention, referring to FIG. 1, a catalytic converter 10 is adapted for use in an exhaust system of an automotive vehicle for treating exhaust gas prior to emission. Converter 10 comprises a catalyst substrate 12 having an outer surface 20 symmetrical about a longitudinal axis 14. Substrate 12 comprises an inlet end 16, an outlet end 18, and a plurality of gas passages (not shown) extending axially therebetween. A preferred substrate shape is a rectangular cylinder having a circular cross section. Alternately, the substrate may suitably have an oval or other cross section. Substrate 12 is preferably formed of a ceramic material and includes a catalyst coating applied to surfaces of the gas passages for treating exhaust gases that flow therethrough.

Substrate 12 is enclosed within a seamless metal housing 22. As used herein, a seamless metal housing refers to a metal housing that does not include a longitudinal seam such as formed by welding or the like. A preferred seamless housing is formed by a spin-forming process as described herein. Housing 22 comprises a midsection 24, an inlet end section 28 and an outlet end section 44. Midsection 24 is symmetrical about axis 14 and surrounds substrate 12 spaced apart from surface 20. A mat 26 formed of thermally insulative material is interposed between midsection 24 and surface 20.

Inlet end section 28 extends axially from midsection 24 adjacent substrate inlet end 16 and includes an inlet opening 32 spaced apart from substrate inlet end 16. Opening 32 is surrounded by a rim 30 adapted for connection to an exhaust pipe. In accordance with this invention, converter 10 further comprises an inner heat shield 34 disposed within end section 28. Inner heat shield 34 is formed of metal and includes a frustoconical section 36 that is radially spaced from section 28 by space 38. Section 36 includes an open end 40 having a diameter greater than the diameter of substrate 12. Inlet end 16 of substrate 12 is received in frustoconical section 36 through end 40, such that the open end 40 is disposed about substrate 12 radially spaced apart from peripheral surface 20. Preferably, clearance is provided between the inner heat shield and substrate end 16 to avoid stress that might otherwise occur due to differential thermal expansion between the metal and ceramic during use and result in damage to the fragile ceramic. Inlet heat shield 36 further comprises a band attached to the inner surface of rim 30 and cooperating therewith in defining inlet 32 to the catalytic converter. During operation, exhaust gases entering the converter through inlet 32, are directed by inner heat shield 34 to inlet end 16 of substrate 12 and flow into and through the gas passages within substrate 12 for treatment. In addition, heat shield 34 insulates end section 28 from the heat of the exhaust gas. In the embodiment in FIG. 1, space 38 contains gas to provide thermal barrier between the end section and the heat shield. Alternately, space 38 may contain ceramic fiber insulation similar to mat 26, or other suitable insulative material.

In the embodiment in FIG. 1, converter 10 includes an outlet end section 44 that is identical to the inlet section 28. Accordingly, outlet end section 44 extends from midsection 24 adjacent outlet end 18 of substrate 12 and includes a rim 46 that defines outlet 48 of the converter 10. Rim 46 is symmetrical about axis 14. An outlet heat shield 50, formed of metal, is disposed within outlet end section 44 and includes a frustoconical section 52 spaced apart from housing outlet end section 44 by a space 56 for thermal insulation. Frustoconical section 52 comprises an open end 54 having a diameter greater than the substrate diameter. Substrate outlet end 18 is received in frustoconical section 52, with open end 54 disposed about substrate 12 spaced apart from peripheral surface 20. Outlet heat shield 50 comprises a band 58 affixed to the inner surface of rim 46 and cooperating therewith in defining outlet 48. Thus, exhaust gases emanating from substrate 12 at outlet end 18 are directed by inner heat shield 52 to outlet 48, which is coupled to an exhaust pipe. In addition, space 56 insulates the housing end section from the heat of the exhaust gases.

Referring now to FIG. 2, there is shown an arrangement for manufacturing catalytic converter 10, and more particularly inlet end section 28, by a spin-forming process in accordance with a preferred embodiment of this invention. Housing 22 is formed from a metal tube 70 symmetrical about an axis 14. Substrate 12 is wrapped in mat 26 and inserted coaxially into a midsection 72 of tube 70. Preferably, substrate 12 is secured within midsection 72 by swedging, spin-forming or other suitable method. Inlet inner heat shield 34 is mounted on a mandrel 76 and inserted into an end 74 of tube 70. The arrangement of tube 70, substrate 12, inner heat shield 34 and mandrel 76 is rotated about axis 14. As the arrangement is rotated, a metal forming tool 80, which in this embodiment comprises a roller 82 rotatable about an axis 84 parallel to axis 14, is radially urged against the outer surface of end 74 and axially advanced to deform the metal and thereby shape inlet end section 28 of the metal housing. Multiple axial passes of tool 80 may be used to incrementally reduce the diameter of the metal to achieve the desired shape. At the end about mandrel 76, the metal is pressed against band 42 to form rim 30 and attach the heat shield to the housing end section. Following spin-forming, mandrel 76 is withdrawn to open inlet 32. Rim 30 and band 42 may be subsequently welded to permanently attach the heat shield to the end section. This may be suitably carried out concurrent with welding of rim 30 to an exhaust pipe in a single operation.

In accordance with the embodiment in FIG. 1, outlet end section 44 is similarly formed by a spin-forming process wherein a preform for outlet inner heat shield 34 is mounted on a mandrel and inserted into end 76 of metal tube 70, whereafter the arrangement is rotated about axis 14 while urging a metal forming tool against the metal to shape the end section.

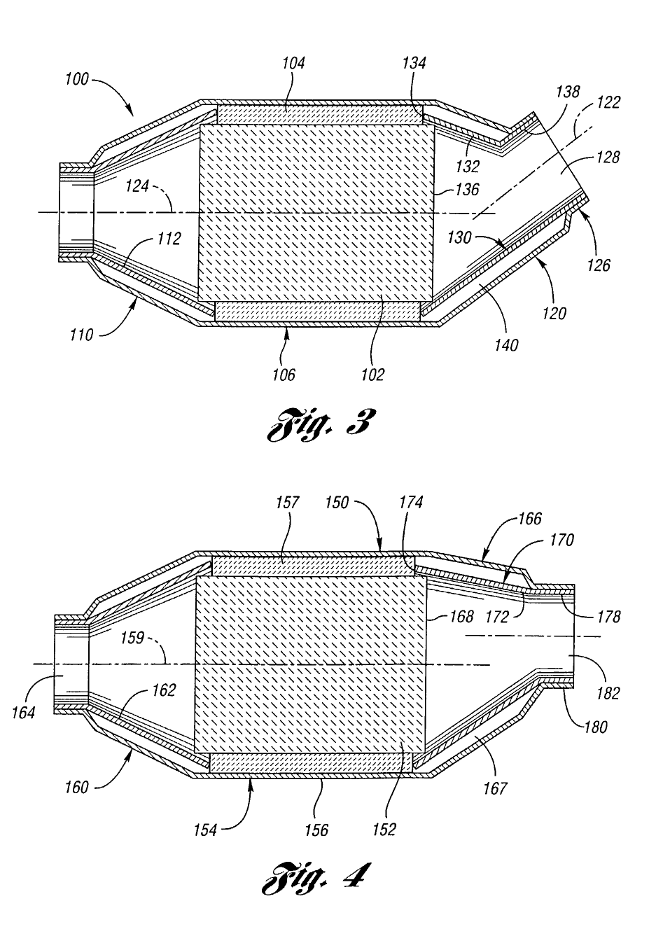

In the described embodiment, the catalytic converter comprises an inlet and an outlet that are symmetrical about the central axis of the catalyst substrate, which corresponds to the axis of rotation during the preferred spin-forming process. In an alternate embodiment, a catalytic converter may be formed having a gas passage, which may be either an inlet or an outlet section, having an axis that is not coincident with the substrate axis. Referring to FIG. 3, there is depicted a catalytic converter 100 that includes a catalyst substrate 102, similar to the substrate 12 in FIG. 1, wrapped within an insulative mat 104. Substrate 102 is symmetrical about axis 124 and is disposed within a metal housing 106 that includes one end section 110 having an inner heat shield 112 and coaxial about axis 124, similar to the inlet end section in FIG. 1. In accordance with this embodiment, converter 100 comprises an end section having opening 128, which may be either an inlet or an outlet, about an axis 122 that obliquely intersects central axis 124 of substrate 102. Opening 128 is surrounded by a rim 126 that is symmetrical about axis 122. In accordance with this invention, an inner heat shield 130 is disposed within end section 120 and includes a frustoconical section 132. Frustoconical section 132 is symmetrical about axis 124 and includes an open end 134 having a diameter greater than the diameter of substrate 102. An end 136 of substrate 102 is inserted into frustoconical section 132, such that end 134 is disposed about substrate 102. Inner heat shield 130 also includes a band 138 that is affixed to rim 126 and cooperates therewith in defining opening 128. When connected to an exhaust pipe to provide an inlet to catalytic converter 100, inner heat shield 130 receives exhaust gas through opening 128 and directs the gas to the end 136 of substrate 102, while insulating the exhaust gases from the housing end section 120 by a space 140 therebetween. When connected to an automotive exhaust system to provide an outlet for converter 100, heat shield 130 is effective in collecting gas emitted from substrate 102 following treatment and directing such gas through opening 128 for emission from the converter.

In another embodiment of this invention shown in FIG. 4, a catalytic converter 150 includes a seamless metal housing 154 having an opening that is offset from the substrate axis 159. Housing 154 includes a midsection 156 about a catalyst substrate 152 and an insulative mat 157, similar to substrate 12 and mat 26 in FIG. 1. Midsection 156 and substrate 152 are symmetrical about axis 159 Housing 150 includes a first end section 160 and an inner heat shield 162 that define an opening 164, which may be either an inlet or an outlet, similar to the arrangement of end section 28 and heat shield 34 in FIG. 1. In accordance with this embodiment, housing 154 includes a second end section 166 that extends from midsection 156 adjacent one end 168 of catalyst substrate 152. An inner heat shield 170 is disposed within end section 166 and includes a frustoconical section 172 that is spaced apart from end section 166 by space 167 to provide thermal insulation. Frustoconical section 172 includes an open end 174 sized larger than the diameter of substrate 152. End 168 of substrate 152 is inserted into frustoconical section 172, with open end 174 disposed about substrate 152. Inner heat shield 174 includes a band 178 affixed to a rim 180 of housing end section 166. In this manner, an opening 182, which may be either a gas inlet or a gas outlet, is defined. When installed as an inlet, heat shield 170 directs the exhaust gas to end 168 of substrate 152 for treatment. When installed as an outlet, heat shield 170 collects exhaust gas emitted from substrate end 168 following treatment and directs the exhaust gases through opening 182. In either event, inner heat shield 170 is spaced apart from housing end section 166 to provide thermal insulation and thereby reduce the temperature of housing 154.

Thus, this invention provides a catalytic converter that includes a seamless metal housing having an end section and an inner heat shield disposed within the end section. The inner heat shield is attached to the end section at an opening that provides an inlet or outlet for the converter. The inner heat shield includes a frustoconical section that receives an end of the catalyst substrate for directing gas flow between the catalyst substrate and the opening. In addition, the frustoconical section is spaced apart from the end section to provide thermal insulation to reduce the temperature of the housing.

While this invention has been described in terms of certain embodiment thereof, it is not intended to be limited to the described embodiments, but only to the extent set forth in the claims that follow.

1. A catalytic converter comprising:
a catalyst substrate having a substrate axis and comprising a first substrate end, a second substrate end, and a plurality of gas passages extending axially therebetween;
a seamless metal housing having a midsection about the catalyst substrate and a first housing end section extending from the midsection adjacent the first substrate end, said first housing end section defining an opening spaced apart from the substrate, and
an inner heat shield affixed to the housing end section at said opening and comprising a frustoconical section, said frustoconical section being disposed within said first housing end section spaced therefrom to form an insulative space therebetween and having an enlarged open end such that the first substrate end is received in the frustoconical section.

2. A catalytic converter according to claim 1 further comprising an insulative mat interposed between the catalyst substrate and the housing midsection.

3. A catalytic converter according to claim 1 wherein the opening is defined by a rim is symmetrical about the substrate axis.

4. A catalytic converter according to claim 1 wherein the opening defined by a rim that is symmetrical about an axis that is parallel to and offset from the substrate axis.

5. A catalytic converter according to claim 1 wherein the opening defined by a rim that is symmetrical about an axis oblique to the substrate axis.

6. A catalytic converter according to claim 1 further comprising an insulative layer disposed between the frustoconical section and the first housing end section.

7. A catalytic converter comprising:
a catalyst substrate having a substrate axis and comprising a substrate inlet end, a substrate outlet end, and a plurality of gas passages extending axially therebetween;
a seamless metal housing having a midsection about the catalyst substrate, a housing inlet end section and a housing outlet end section, said housing inlet end section extending from the midsection adjacent the substrate inlet end and comprising an inlet rim defining an exhaust gas inlet spaced apart form the substrate inlet end, said housing outlet end section extending from the midsection adjacent the substrate outlet end and comprising an outlet rim defining an exhaust gas outlet spaced apart from the substrate outlet end;
an inlet inner heat shield comprising a frustoconical section disposed within the housing inlet end section spaced apart therefrom and having an enlarged open end disposed about the catalyst substrate such that the substrate inlet end is received in the frustoconical section; said inlet inner heat shield being affixed to said housing inlet end section at said inlet rim and effective for directing exhaust gas admitted through said exhaust gas inlet to the substrate inlet end, and
an outlet inner heat shield comprising a frustoconical section disposed within the housing outlet end section spaced apart therefrom and having an enlarged open end disposed about the catalyst substrate such that the substrate outlet end is received in the frustoconical section; said outlet inner heat shield being affixed to said housing outlet end section at said housing outlet rim and effective for directing exhaust gas emitted from the substrate outlet end to said exhaust gas outlet.

8. A catalytic converter according to claim 7 further comprising an insulative layer disposed between the frustoconical section of the inlet inner heat shield and the inlet housing end section.

9. A catalytic converter according to claim 7 further comprising an insulative layer disposed between the frustoconical section of the outlet inner heat shield and the outlet housing end section.

10. A catalytic converter according to claim 7 wherein the inlet inner heat shield comprises a band received in the inlet rim.

11. A catalytic converter according to claim 7 wherein the outlet inner heat shield comprises a band received in the outlet rim.
